(19) United States
(12) Patent Application Publication
(10) Pub. No.: US 2021/0120957 A1
(43) Pub. Date: Apr. 29, 2021

(54) Modules & Cells for Mattress & Furniture

(71) Applicant: AHMAD AMIRI, RICHMOND HILL (CA)

(72) Inventor: AHMAD AMIRI, RICHMOND HILL (CA)

(73) Assignee: INVENTALL INC., RICHMOND HILL (CA)

(21) Appl. No.: 16/602,555

(22) Filed: Oct. 31, 2019

Related U.S. Application Data
(60) Provisional application No. 62/752,727, filed on Oct. 30, 2018.

(51) Int. Cl. A47C 7/14; A47C 7/18; A47C 27/06; A47C 7/34; A47C 27/20; A47C 27/14; A47C 7/35

(52) U.S. Cl. CPC A47C 7/14; A47C 7/18; A47C 27/065; A47C 7/35; A47C 27/20; A47C 27/148; A47C 7/34

(57) ABSTRACT

A cushioning module used to make various furniture such as mattresses, made of a matrix of cells, each cell made of typically a cuboid base supporting a typically cuboid top, made of a compressible and retractable material such as foam, which top has a smaller diameter than the base so that when said cells are tightly arranged, each top is apart from adjacent tops, enabling it to contract and retract spring like. Said matrix inside a bag which tightly embraces it from all sides and has an opening via which each cell can be removed and replaced. Pods can have a smoothing layer spread over said tops, means for fastening them together, carrying handle, stiffening pads along their lateral sides and a cover around their assembly. Cells can also be sacks filled with cotton, wool, dawn, foam bits or air which can be let out and re-filled.

This application claims priority of U.S. Provisional Application 62/752,727 filed 2018 Oct. 30.

The purpose of the Invention: Is to provide desirable features of a Mattress, especially those shown and weighted in the Table here, all of which are either not existing in prior art or not to the same degree or with same ease. For example, some mattresses can be customized but not at home by the uses and easily, but requires a visit by experts or to be done by the factory, once or if shipped back.

Table: Below shows the Features and Advantages the Invention addresses, and Deficiencies of Prior Art.

Modules (Pods): The Invention is a range of Furniture Modules or Pods, a unit which is generally, but not always, shopped, shipped, carried, a number of which are assembled into a Mattress or other Furniture such as Seat, Sofa, Hip Rest, Back Rest, Head Rest, Pet Rest, Pillow, etc.

Cells: Each Pod harbors a number of Cells, made of Foam, or one or more Sacks (Bags) filled with a suitable Filler.

Some suitable Cell Sack Fillers are Foam, Cotton, Wool, Down, Feather, Synthetic Fibres, Sand, Ping Pong, Squash, Tennis Balls, Wastes, Bits or Beans of Polystyrene, Foam, Fabric, . . . .

Sacks can be filled with Air and or Water, which can conduct heat and cold from an underlying, side or other source, to a user on top. Air & Water Sacks may or should have Inlets and Release Valves. They may also have preferably flexible Tubes to connect them to other Sacks, to transfer air or water between them, thus for example, filling one Sack can fill a number of others and different Zones can have their own pressure. Said Tubes can be connected to Sacks via Valves that close once the Tube is removed, preventing Air or Water escape. Hence, Tubes can be disconnected from some Sacks, perhaps connected to others, for numerous permutations of connected and or disconnected Sacks and Zones.

Sacks, especially water and air filled, can have a non-stretch mesh or sheet layer in their skin to prevent excess bulging or doming, a Solid Plate may be used for Top and or Bottom of each Sack, but part of some sides, such as the Sacks Base Sides which need not be flexibility.

Cells can have a number of Sections along their height, typically, but not necessarily, a Base, a Top and possibly layers in between. Thus they can have all layers that other mattresses or furniture use in their structure, such a memory foam layer, cool layer, etc. One or more Layers can be inside same Sack. One Cell can have different Fillers, say Air for Top Section and Foam for Base.

The Base can be a Solid Box, while other Sections above it can be Foam or Sacks. Solid Base better be an empty square that folds and flattens like a Rhombus with hinged edges, for foldability.

Cells can have various cross sections, even different for their Base, say Square and Top, say Cylindrical.

If a Sack has planar Sides, such as Cube, Cuboid, Prism, etc, non-stretch thread(s) and or band(s), inside the Sack, stuck to the inner surface of one potentially bulging Side and that of an opposing Side, Edge, and or Vertex can limit bulging under inner air, water or fill pressure.

Cells can be of different cross sections by shape and size. For example Prism Cells with triangular cross section can be inserted between Cylindrical ones of larger diameter.

Cells can be of different Height, Firmness, Cross Section, Material, even within the same Module.

Even Spring Cells and Spring-in-Foam Cells are possible.

Matrix: Is to hold the Cells in place, in rows and or columns. One optimal Matrix is a Honeycomb, made of Cell holding Well(s) or Cavity(s) like structure with thin walls. Walls can be solid bands, panels or pads, preferably made to fold along their junction with a crossing wall, using any of many known methods, enabling typically square Wells to turn Rhombus to shrink the Matrix. Another option is that Matrix is made of preferably synthetic fabrics, suitable for the purpose, such as being dust repellant, washable, resilient, cheap, weldable, sew-able, etc. To prevent crumbling of the Well's Walls, they can have a number of solid strips inserted, in similar way as strips inserts within corners of some shirt collars.

Another option is to insert rigid or semi rigid Pads into Sleeves at side Wall's of the Wells, particularly for Walls that form the Periphery of the Mattress or other Assembly of Pods which is prone to crumbling when one is sitting on it or from pressure of a tight Cover.

The bottom of the Wells can be open, leaving the underneath of the Cells exposed to touching and relying on any underlying support, such as a bed platform, but better be closed, better not fully, to allow escape for any dirt or particles that may fall in. Good options are a Net or a side to side or diagonal Band.

Each Cell better be firmed inside its Well, by many known means, not to dislodge. One option is Velcro attaching the underneath of the Cell to the Bottom of the Well. Other techniques rely on the Cell's Base being wider than the part of the Cell just above same Base. Then Lips around the rim of the Well housing such Base, turning inward towards the inside of the Well, keep the Base, hence the Cell in place as the Wells top opening is reduced in size. Also a thread, band or triangle connecting at the two sides of least two diagonally opposed corners of the Wells works. Similar approaches work for Wells with non rectangular cross sections.

One kid of Module uses a Cuboid Bag holding a number of Cells arranged in Row(s) and or Column(s), with or without a Wells Matrix, which Bag can be of fabric or even a net, with zipped, laced, buttoned, lip or other known opening(s). These are more useful as Modules or Pods to assemble as non-mattress furniture.

Bags can have openings for any Handle or means of attaching adjacent Pods placed on the Matrix inside said Bag, to be operable and or accessible from outside the Bag.

Another version of same is a Matrix with No Wells, like a Box, holding Cells, in row(s) and or column(s).

Modules better have at least one carrying Handle, attached to said Bag or to the Matrix positioned to exit from an opening or slit in any Bag holding the Matrix.

Matrices can have Row(s) and or Column(s) of one or more Wells, each Well housing typically one Cell, but more if a higher resolution of or smaller Cells are preferred.

Each Pod better have means of being Attached to at least one adjacent Pod, from at least one location, preferably at many external corners of the Matrix or Bag, preferably close to the underneath of Matrix or Bag. Where adjacent Pods are to fold towards each other top to top, to conform to an uneven or zigzag bed surface, said Attachment points be as far as possible from the underneath of the Pod.

Pod to Pod Attachments can be via any of known means, such as Laces, Buttons, Cuff Pins, Velcro, Zips, Clips, Pins, Safety Pins, elastic or non-stretch Loops around Buttons on adjacent Pods, . . . .

Pods can be attached together as an Assembly, such as a Mattress. One way is to have one or more Belts or Ropes around the external wall of the Assembly, preferably going through Loops such as Belt Loops to prevent sliding of the Belt off the Assembly. One Rope at close to the lower edge of the external Wall of the Assembly and another close to the top said Wall should be sufficient to keep all in place. However, inner Pods not touched by said Belts or Ropes better be adhered to adjacent ones by other means, some discussed here. Another way is to have an Overall Cover, like a Mattress Cover, much or all of the Assembly. In case of a Mattress, such Cover better enclose the top, side walls and at least some of the underneath, better from all sides, like most mattress covers. Better a tightening elastic or non-stretch Rope ensure that the Cover is tightly pushing together all Pods enclosed.

Wells can have an inner Wall to hold the Cell and an outer Wall to create a distance with adjacent Wells. This ease Cell Plunging, less Cell material, cooling channels and space for any Pipes between Air or Water filled Cells. Inner and outer Walls are kept apart by a sufficient number of solid or soft (say fabric) Bridges between and attached to both said Walls at technically suitable intervals. When Wells are Cylindrical, 3 Bridges, equidistance of each other should do. For Square Wells, Bridges better connect each Inner Edge of the Outer Wall to the nearest Outer Edge of the Inner Wall.

Inner and Outer Walls need not have the same cross section, as one can have polygon the other circular cross section to suit manufacturing, functional and or aesthetic designs. In fact hexagonal Outer Walls can be made of soft or solid sides, hinged together, preferably with soft or fabric (cloth) hinges, to fold flat when needed, yet Inner Walls can be cylindrical to firmly wrap around and hold cylindrical Cells, which are often optimal for filled Cells.

Not all Cells need a Well, as many can be supported by adjacent Cells or other means.

Modules can be made by a Matrix of Cells held together by a Belt or Rope around the peripheral ones, which if equipped with Loops like those of Pants, said Belt or Rope can run through them to avoid slippage.

Another way of preventing slippage is horizontal Grooves on the exterior of the Cells, through which the Rope or Belt runs.

Modules can be made by Interlocking Cells, for example the Base of each Cell has an extruded Cylinder vertically attached to its Base, inserted into a vertical Bore, with preferably more than 180 degrees part circular cross section at the side of an adjacent Cell.

Overlay: An Optional Overly Layer can be on top of Cells, covering Cells of the same Module, especially if used for non-mattress furniture assemblies, some Modules, one User's Modules or all of a Mattress. Different Modules can have different material, thickness or other attributes. Especially, one User may prefer memory foam and the other Cotton.

Cover: An overall Cover is often needed, which should suit the Mattress or other Furniture.

Images & Drawings: Show, at least to the Skilled, many other features and techniques introduced here, often better than words.

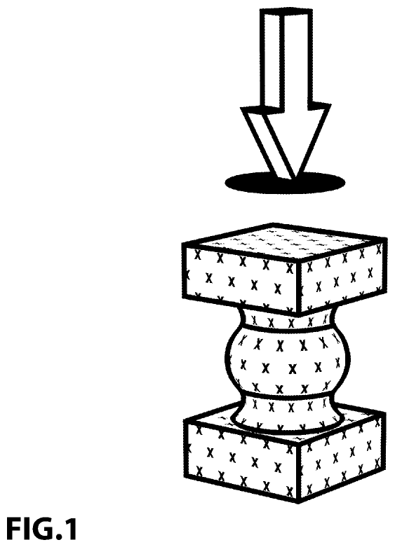

FIG. 1 shows one Cell designed for Plunging

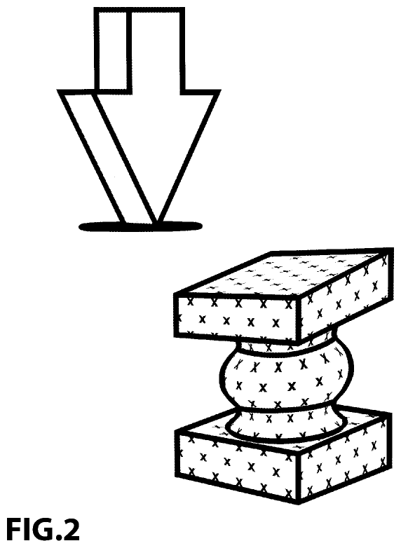

FIG. 2 shows one Cell designed to Plunge, with a Top that also gives around all corners

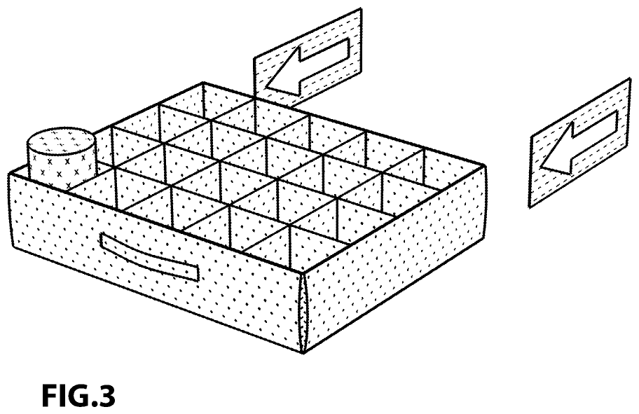

FIG. 3 shows a Pod with Sleeves in it external Walls, allowing Semi or Full Rigid Pads in

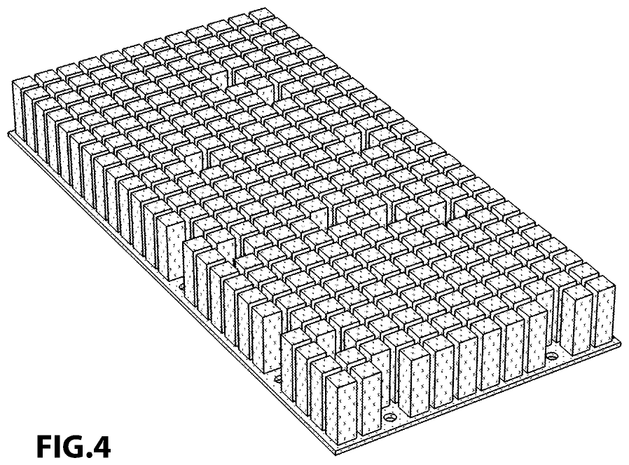

FIG. 4 shows Cells placed on a Mat with Moles that enter a cavity under each Cell

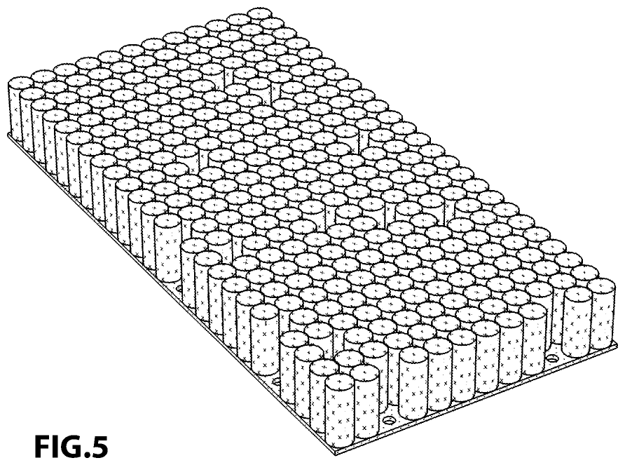

FIG. 5 shows Cells whose bottom has a Mole to enter the cavities on an undermat

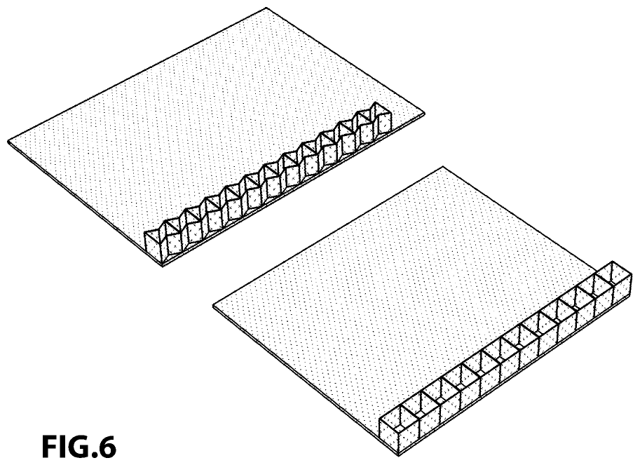

FIG. 6 shows a kind of Matrix Well whose walls can fold

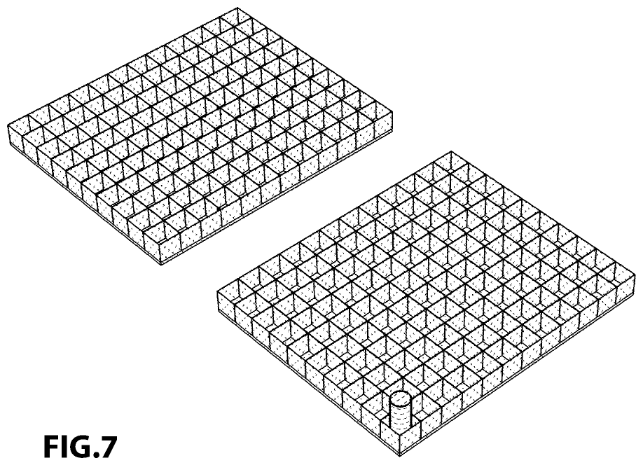

FIG. 7 shows a Matrix with square Wells receiving Cylindrical Cell(s)

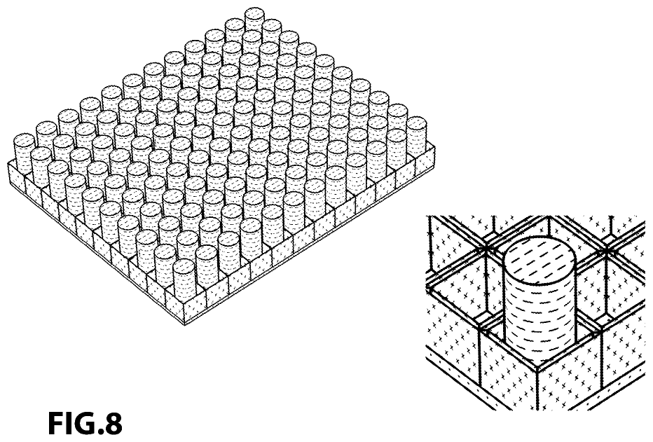

FIG. 8 shows a blow up of a Matrix with square Wells receiving Cylindrical Cell(s)

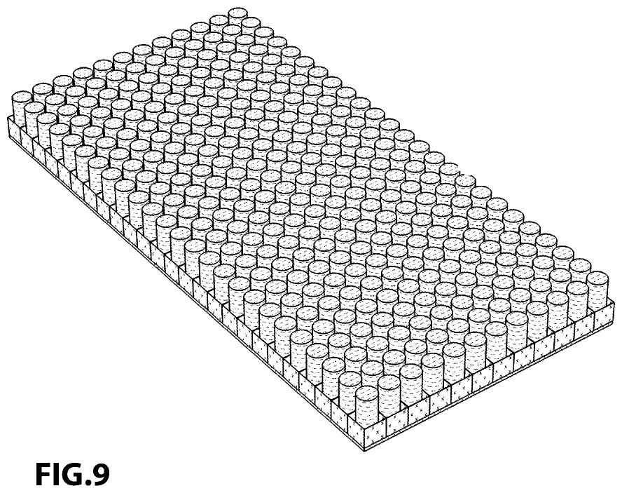

FIG. 9 shows a Matrix with square Wells receiving Cylindrical Cell(s)—filled

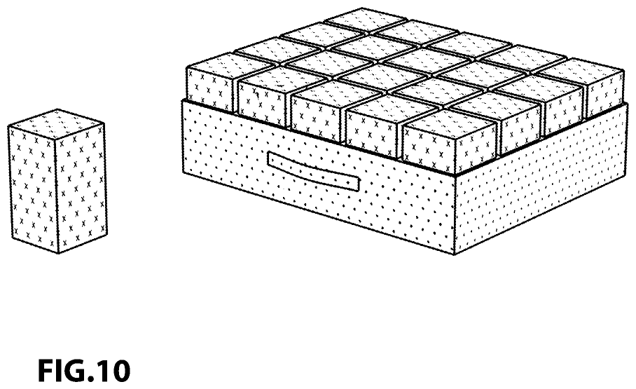

FIG. 10 shows a Matrix with a Handle, with square Wells with Cuboid Cells, also an isolated Cell

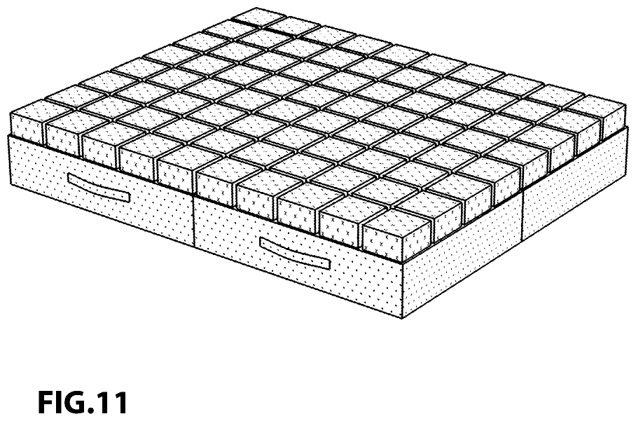

FIG. 11 shows an Assembly of Pods (Matrices) with Handles

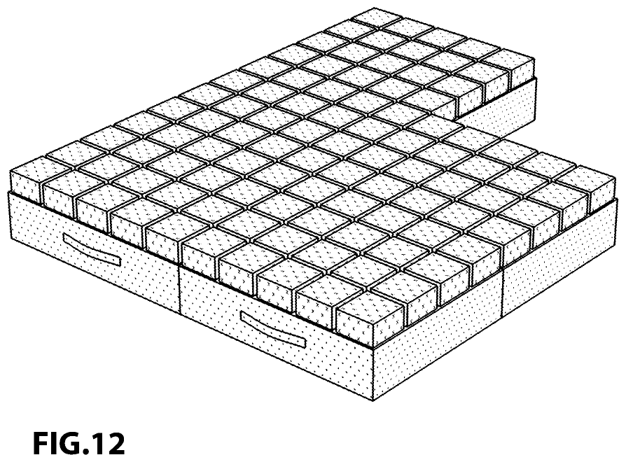

FIG. 12 shows an Assembly of Pods (Matrices) with Handles, adding more Pods

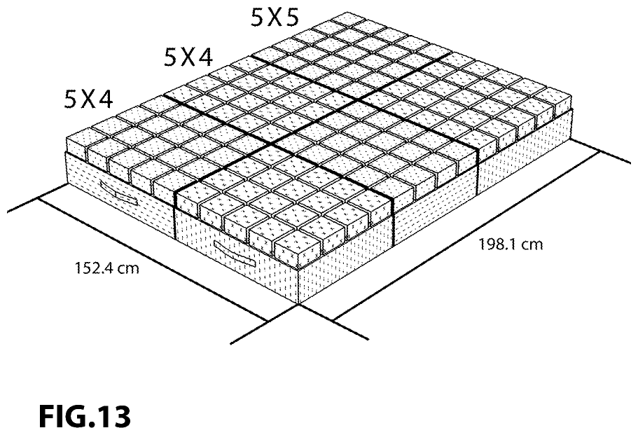

FIG. 13 shows a Queen size Mattress Assembly of Pods, each having 4×5 or 5×5 Cells

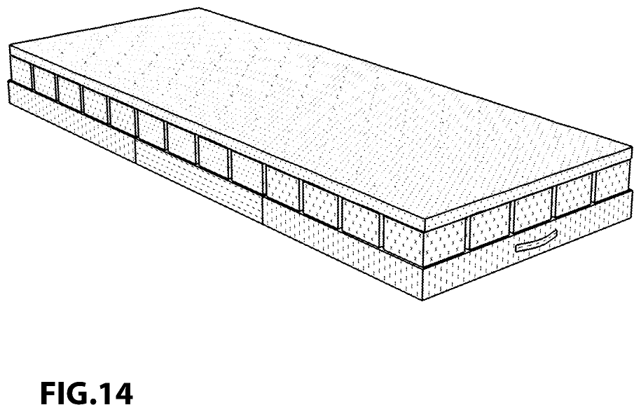

FIG. 14 shows a Mattress with an Overlay

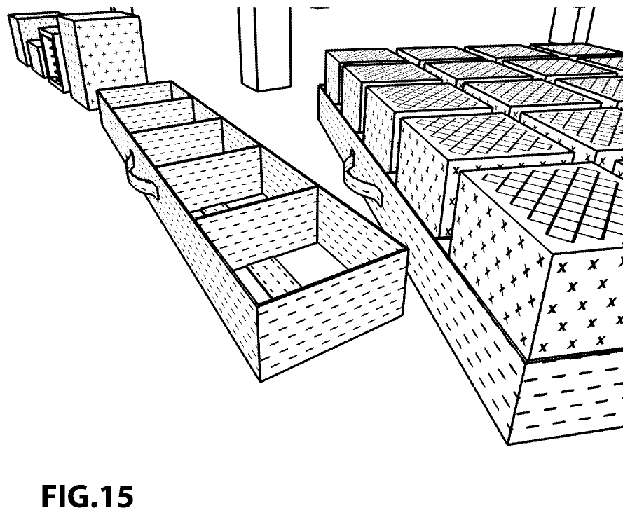

FIG. 15 shows a Matrix of 1×5 Cells, with a Band across the bottom of Cells to prevent Cell drop out

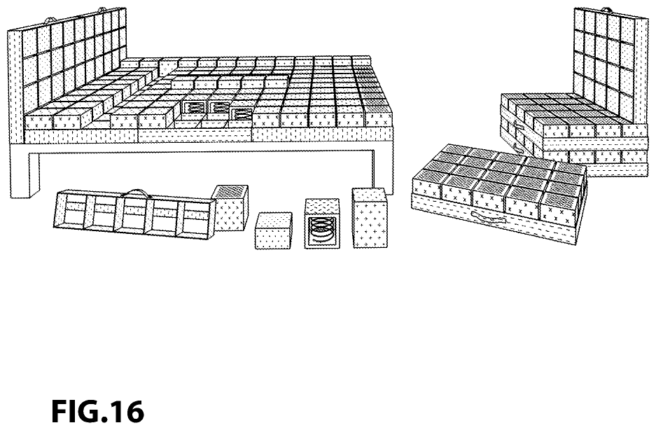

FIG. 16 shows a Mattress constructed with Pods, Cells of different heights and firmness, some using Coil Springs, also Head Rest, Seat, Cells and an empty Pod

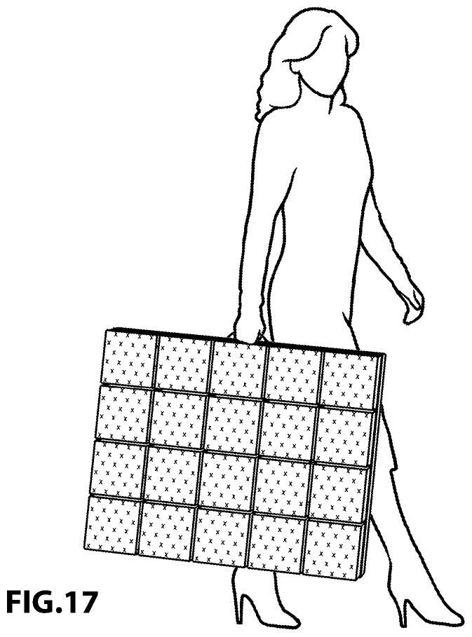

FIG. 17 shows a person carrying one Pod with ease

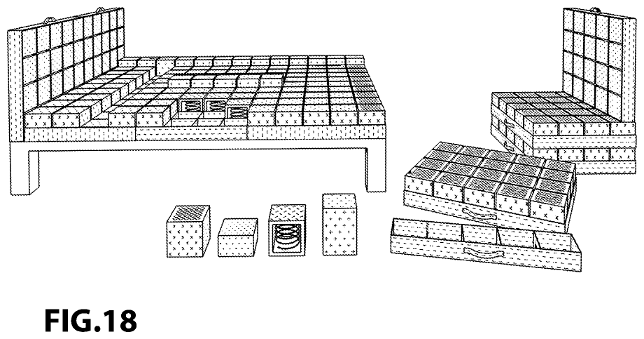

FIG. 18 shows a Mattress constructed with Pods, Cells of different heights and firmness, some using Coil Springs, also Head Rest, Seat, Cells and an empty Pod

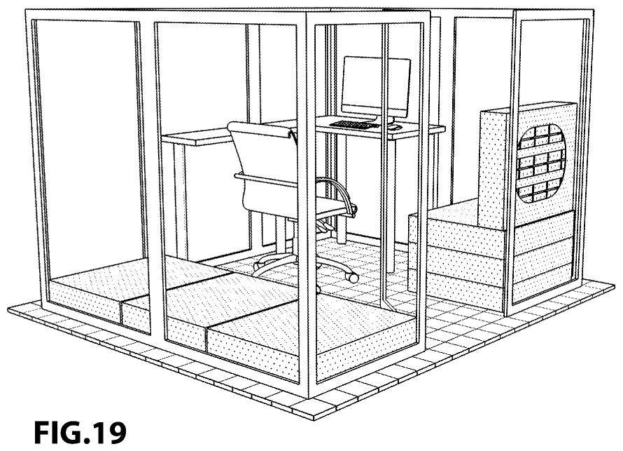

FIG. 19 shows an Office Cubicle in which a Mattress and Seat, made of Pods

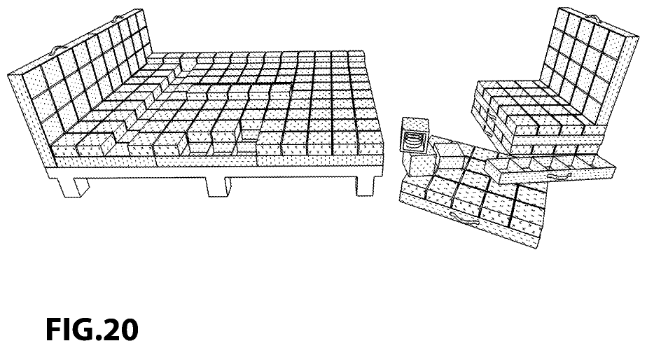

FIG. 20 shows a Mattress constructed with Pods, Cells of different heights and firmness, some using Coil Springs, also Head Rest, Seat, Cells and an empty Pod

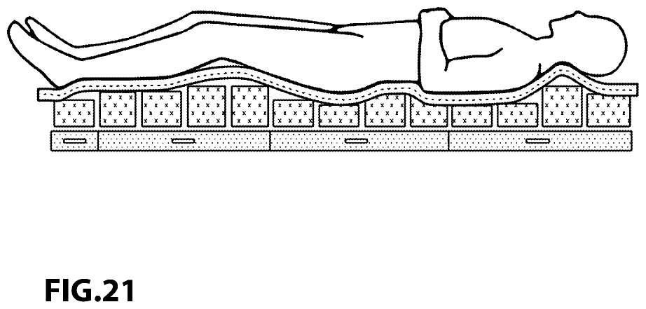

FIG. 21 shows the cross section of a Mattress with Cells of different Heights for a desired Contour

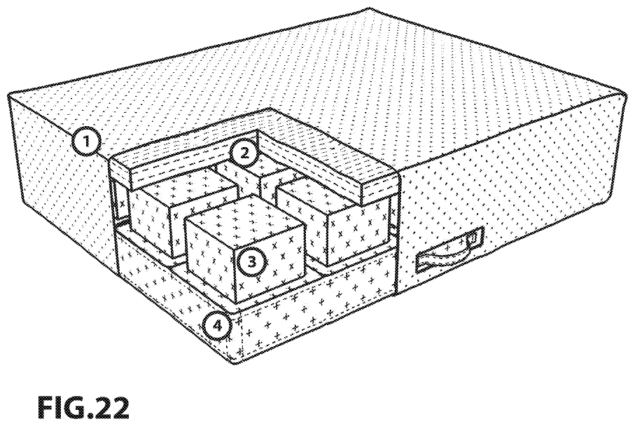

FIG. 22 shows a Pod with (1) enclosing Bag, (2) Overlay, (3) Cells and (4) Matrix

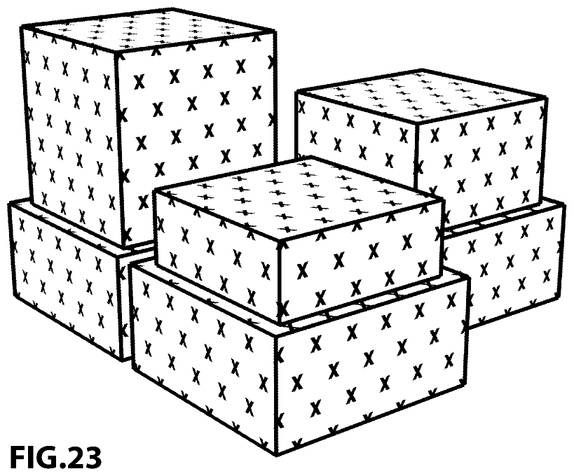

FIG. 23 shows 3 Cells of different Heights and Color, to show different Firmness

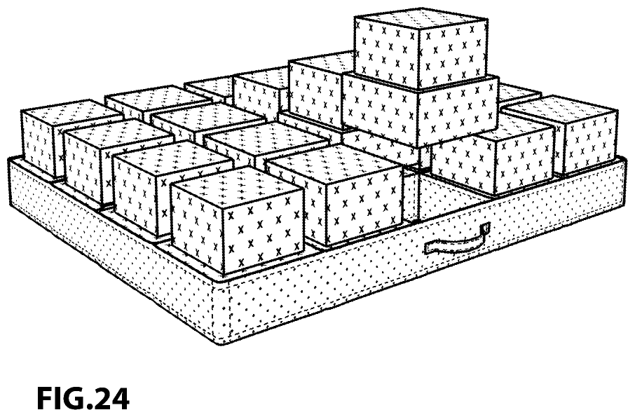

FIG. 24 shows a Pod with some Cells being Installed or Removed

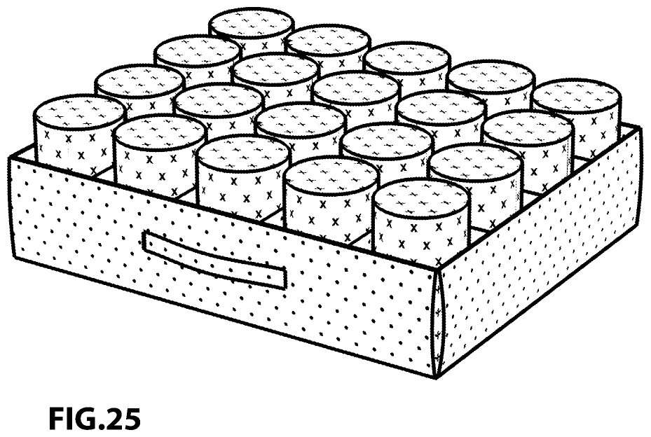

FIG. 25 shows a Pod, with a Handle, without Wells, holding a number or Cells

CellFoam—Rates 9 out of 9 on all Features. Empowers Users to Design, Assemble, Reconfigure, Split, Combine, Wash, Upgrade, Repair, Ship, Move, and much More. BoxCoils Rates 0 on all.

Table Compares CellFoam with an Expensive Pixel Mattress (Col. R), Foam Mattresses In a Box (Col. F), Air Mattresses (Col. A).

R, 4000 USD for Queen size, inferior on all Features, Customized only via Factory (f), not by User.

You Score: Weight each Feature (0 to 9) and Rate a Mattress for said Feature (0-9), add for all Lines.

| W | Desired Features—Weighted 0 to 9 | R | F | A |
|---|---|---|---|---|
| 9 | Risk Free, No Hassle, Fun, Easy to Buy—No Big | 2 | 5 | 5 |
| | Plan or Effort | | | |
| 9 | Machine Wash Each Cell, Overly & Base at Home | 5 | 0 | 5 |
| 9 | Choose & Change Each Cell, Overlay, Base & Cover | f | 0 | 0 |
| 9 | Choose & Change All Specs of Own Half | f | 0 | 9 |
| 9 | Choose & Change Firmness of Each Cell | f | 0 | 0 |
| 9 | Choose & Change Overlay Material | 7 | 7 | 7 |
| 9 | No Bed Bug, Odor, Soil, Stain, . . . | 5 | 0 | 7 |
| 9 | Enables Choice of Hotels that Wash their Mattresses | 5 | 0 | 7 |
| 8 | Pet Friendly, DIY Wash or Change Soiled Parts | 5 | 0 | 5 |
| 8 | Converts to Seat or Sofa to clear Space | 0 | 0 | 0 |
| 8 | Super Eco- Recycle 100%, Reuse, Resell | 3 | 4 | 5 |
| 8 | Office Cubicle Bed—Converts to Office Guest Seat | 0 | 0 | 0 |
| 7 | Split Queen & King to Twins | 0 | 0 | 0 |
| 7 | Combine Twins—No Gap or Stiff Midline | 0 | 0 | 0 |
| 7 | Easy Folding for Raised Back & Bent Knee Bed | 7 | 3 | 9 |
| 6 | Air Circulation Channels to Cool | 9 | 0 | 6 |
| 6 | Unaided Carry & Load | 3 | 3 | 9 |
| 6 | Easy to Shelf, Demo, Test & Buy in any shop | 2 | 7 | 7 |
| 6 | DIY Assembly, | f | 9 | 9 |
| 6 | Move by Bus, Bike or Walk | 0 | 4 | 9 |
| 6 | Re-Shrink to Store or Move | 3 | 3 | 9 |
| 6 | Easy to Sell, Donate & Ship Post Use | 3 | 1 | 9 |
| 6 | Enables Wide Variety—All Good Quality | 5 | 4 | 2 |
| 6 | DIY Upgrade of Looks, Materials & other Specs | f | 0 | 0 |
| 5 | User Can Change Cell Type to Foam, Coil, Air, . . . | 0 | 0 | 0 |
| 5 | User can Change Hight of each Cell | 0 | 0 | 0 |
| 5 | User can Change Width & Length of Mattress | 0 | 0 | 0 |
| 4 | DIY Fall Preventing Soft Walls | 0 | 0 | 0 |
| 4 | DIY Dips for cuddling arm | 0 | 0 | 0 |
| 4 | DIY Soft Kick Barrier | 0 | 0 | 0 |
| 4 | User can change Perimeter Stiffness | 0 | 0 | 0 |

Clarifications:
Said Wells can be Cylinders or take other names depending on their shape, position in relation or distance to adjacent Wells, being above or below any material, media or substrate holding it in desired place.
Rigidifying Pads inserted in Wells can be inside Sleeves or Pockets places inside, outside or sandwiched between layers of the Well Wall(s). Said Sleeves and or Pockets can be interconnected to allow the same Pad to run through a Wall of an Adjacent Well and perhaps the next well, stiffening a row of Well Walls.
Rigidifying Pads inserted in Wells can be placed between a Well's Cell and the Well's Wall tangent to same Cell, in which case there can be slits in the Wells Walls to allow the same Pad to extend into adjacent Well, stiffening Walls of many Wells.
The Table identifies some 31 of even more advantages of the Invention, when used to make Mattresses, 20 of which can be found in other mattresses, not all, but one or few of which in same mattress, but 11 are not found in any other mattress.
No Prior Art enables simplicity to make for Manufacturer, store for Distributor, demo for Retailer, more so for User who can easily carry, move, assemble, customize, re-customize, wash, donate, re-sell and more.
Good Cross Sections for Wells are Circle, Ellipse, Triangle, Rectangle, Square and Hexagon.
Logical Cross Section of each Cell Base that of the Well it is inserted in, as each outer surface of said Base touches and may lien on one Inner side of its harbouring Well.
Cell Tops Cross Section better be the same as that of same Cell's Base.
Other variations are possible, say Cylindrical Top with circular cross section above a Base with Hexagonal or Square cross section, which base may be easier to make and adhere to other ones.
Cells should resist (1) falling aside, even under load vertically exerted over its Top, (2) twist, which can be provided by the Wells Walls holding the Cell Base.
Cells should resist falling out over the Well, falling off above the Well, assisted by Gravity, Friction between Well's Cell Base's outer surfaces, Overlay, Module Cover or Overall Cover, but various other means, such as a Velcro under the Base attaching it to Well Bottom are possible.
Cells should resist falling down from the bottom of the Well, assisted by Friction with Well, Well Bottom being at least partially closed, underlying Platform, such as a Bed, Module or Overall Cover extended underneath the Module, and other technical means.

1. (canceled)

2- A cushioning module for a furniture, called a “pod” here, having a “matrix” of at least one row and at least one column of “cell(s)”, each cell having a “base” chosen from triangular prism, cubic, cuboid, hexagonal prism or cylindrical, arranged such that at least one side surface of each base is tangential to a side surface of at least one adjacent cell's base, each cell having a compressible and retractable section called Cell's “top” here, attached to its base and sized to be detached from adjacent cell tops in said arrangement, said matrix of cells is inside a bad of substantially cuboid shape, made of soft and flexible material at least where touching said cell tops, said bags dimensions are such to hold the bases of adjacent cells tightly tangential to each other, which bag has at least one opening via which each of said cells can be moved in and out.

3- Claim 2 where at least the cell top of each cell is of a material selected from a list of at least natural foam, synthetic foam, memory foam, cooling foam, foam like material, coil spring, coil spring covered in foam like material, where said selection is made for each individual cell.

4- Claim 2 where the cell top and base are each of cuboid shape with a square cross section, each side plane of the top is parallel at least to one side plane of the base, both top and base made of a desired versions of foam, and at least the top has at least one layer of foam with at least one different property than the foam used for the rest of tops body.

5- Claim 2 where said furniture is chosen from a list of a mattress, sofa, seat, padded chair, car seat, pet mat, headrest, backrest, hip rest or other, said pod, has means to hold it to at least one adjacent pod, at least when used as part of an assembly of an integral furniture

6- Pod of claim 2 where at least some of the sides of said bag which are adjacent to the bases of said cells have sleeves into which rigidifying pad(s) with desired rigidity can be inserted.

7- Claim 2 where at least some of the cells have at least one layer of a different material and or construction than the rest of same top's body, which layer has at least one desired property such as cooling, memory, high collapsibility under pressure, lateral flex, etc.

8- Claim 2 where at least one cell is different in at least one of height, firmness, shape, diameter, width, color, material, construction, form, and or any other feature, from at least one adjacent cell.

9- Claim 2 where the top of at least one cell is different in shape and or material from the base of same cell.

10- Claim 2 where at least one cell top has a head supported by said top, away from same cell's base, which head's diameter extends beyond the diameter of where said joins said head, enabling the head to tilt towards said base.

11- Claim 2 were at least the cell top of at least one cell is a “sack” filled with compressible and retracting substance(s) chosen from a list of at least cotton, wool, feather, dawn, foam, foam bits, air, water, filled rubber balls, hollow rubber balls, tennis balls and or industrial waste, chosen individually for each cell.

12- Claim 2 were at least the cell top of each cell is a “sack” filled with compressible and retracting substance(s) chosen from a list of at least cotton, wool, feather, dawn, any variety of foam, foam bits, air, water, filled rubber balls, hollow rubber balls, tennis balls and or industrial waste, chosen individually for each cell, where at least one sack has at least one non stretch but flexible layer across at least part of its curved surfaces, to prevent bulging.

13- Claim 2 were at least the cell top of each cell is a “sack” filled with compressible and retracting substance(s) chosen from a list of at least cotton, wool, feather, dawn, any variety of foam, foam bits, air, water, filled rubber balls, hollow rubber balls, tennis balls and or industrial waste, chosen individually for each cell, where at least one sack has at least one rigid layer across at least part of at least one of its non-curved planar surfaces, to prevent bulging.

14- Claim 2 where an overlay layer is placed over at least some of said tops.

15- Claim 2 where an overlay layer is placed over at least some of said tops, which overlay extends beyond one pod to at least one adjacent pod.

16- Claim 2 where an overlay layer is placed over at least some of said tops, which overlay is of a material that has at least one desired property not provided in desired way or amount in absence of said overlay.

17- claim 2 where said pod has means for being fastened to at least one adjacent pod, in at least one location.

18- Claim 2 where said furniture is chosen from a list of at least mattress, sofa, seat, padded chair, car seat, pet mat, headrest, backrest and hip rest, said pod, has means to hold it to at least one adjacent pod, at least when used as part of an assembly of an integral furniture

19- Claim 2 where a number of said Pods are arranged as a mattress, which assembly of pods is covered inside cover sheet covers the mattress top, sides and at least part the underneath of said mattress, and is sized to hold said pods tightly together.

20- Claim 2 where said pod has a handle to aid carrying it.

21- Claim 2 where said at least part of said bag is a net like material.
